(19) United States
(12) Patent Application Publication
(10) Pub. No.: US 2003/0110498 A1
(43) Pub. Date: Jun. 12, 2003

(54) Methods, systems, and apparatus for tuning television components using an internet appliance

(75) Inventor: Christopher J. Stone, Newtown, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/016,345

(22) Filed: Dec. 10, 2001

(51) Int. Cl. H04N 5/445; H04N 7/173

(52) U.S. Cl. 725/42; 725/60; 725/110

(57) ABSTRACT

Methods, systems, and apparatus for tuning a television appliance using an internet appliance are provided. A first network provides a program advertisement to the internet appliance. A second network provides channel map information to the internet appliance, which channel map information identifies a channel for a program advertised in the program advertisement. The program advertisement is displayed on the internet appliance. The advertised program may be selected via interaction with the program advertisement using a user interface associated with the internet appliance. A tune command is communicated to the television appliance from the internet appliance in response to the interaction with the program advertisement. The television appliance tunes to the channel advertised in the program advertisement in response to the tune command. The internet appliance creates the tune command for the advertised program based on the channel map information.

### BACKGROUND OF THE INVENTION

The present invention relates generally to the field of digital communications. In particular, the present invention provides methods, systems, and apparatus for tuning television components (e.g., a television appliance, such as a television set, video recorder, personal versatile recorder (PVR), etc.) using an internet appliance. In particular, the present invention provides for the tuning of a television appliance in response to interaction with an interactive advertisement displayed on an internet appliance.

Various forms of interactive electronic program guides are provided in the prior art. Commonly assigned U.S. Pat. No. 5,844,620 entitled “Method and Apparatus for Displaying an Interactive Television Program Guide” provides one example of such a prior art interactive program guide for display on a television screen. In addition, the prior art also includes remote control devices having a display area for displaying interactive program guide information, including U.S. Pat. No. 6,130,726 entitled “Program Guide on a Remote Control Display” to Darbee, et al.

Further, the prior art includes various interactive television appliances which provide internet-enabled features, such as interactive television, links to web sites related to television program content, electronic games, electronic shopping, and the like. Electronic program guide information is also available from various web sites, and can be viewed on such internet-enabled television appliances.

It would be advantageous to be able to tune a television appliance to a particular television program using an internet appliance. It would be further advantageous to be able to tune to a particular television program in response to an advertisement displayed on the internet appliance. It would be still further advantageous to provide the advertisement in the form of a pop-up advertisement on the internet appliance display.

The methods, systems, and apparatus of the present invention provide the foregoing and other advantages.

### SUMMARY OF THE INVENTION

The present invention provides methods, systems, and apparatus for tuning a television appliance using an internet appliance. A first network provides a program advertisement to the internet appliance. A second network provides channel map information to the internet appliance, which channel map information identifies a channel for a program advertised in the program advertisement. The program advertisement is displayed on the internet appliance, for example in the form of a Hyper Text Mark-Up Link (HTML). The internet appliance creates a tune command with the appropriate channel information from the channel map information for the advertised program. The advertised program may be selected via interaction with the program advertisement using a user interface associated with the internet appliance. A tune command is communicated to the television appliance from the internet appliance in response to the interaction with the program advertisement. The television appliance tunes to the channel advertised in the program advertisement in response to the tune command generated by the interaction with the program advertisement.

### BRIEF DESCRIPTION OF THE DRAWINGS

The present invention will hereinafter be described in conjunction with the appended drawing figures, wherein like numerals denote like elements, and:

FIG. 1 is a block diagram of an exemplary embodiment of the invention;

FIG. 2 is a block diagram of a second example embodiment of the invention; and

FIG. 3 is a block diagram of an exemplary embodiment of an internet appliance of the present invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

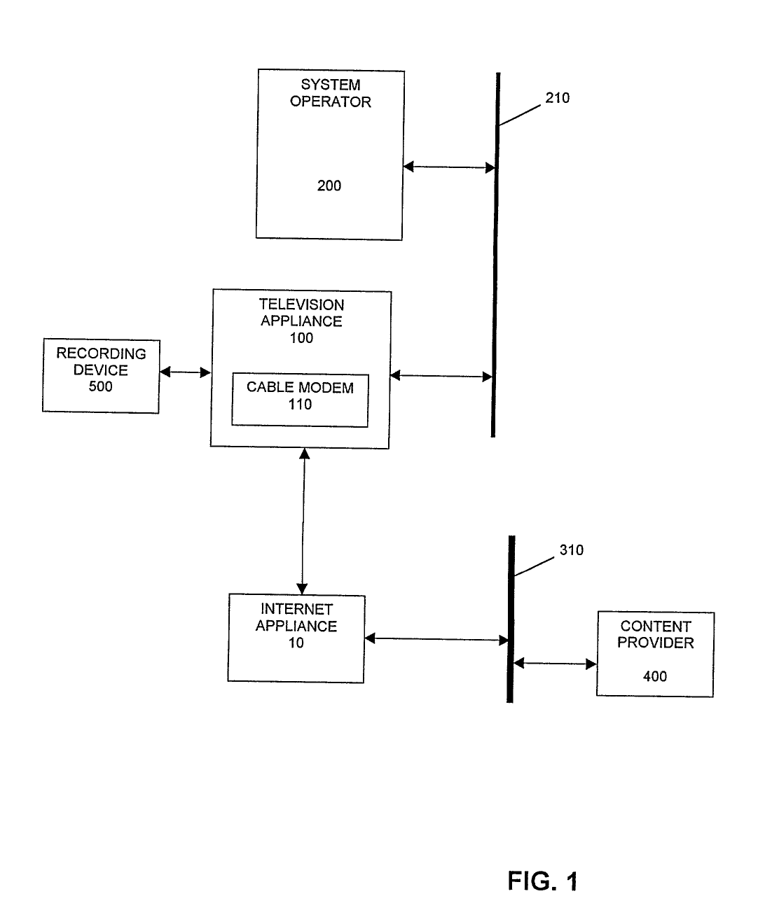

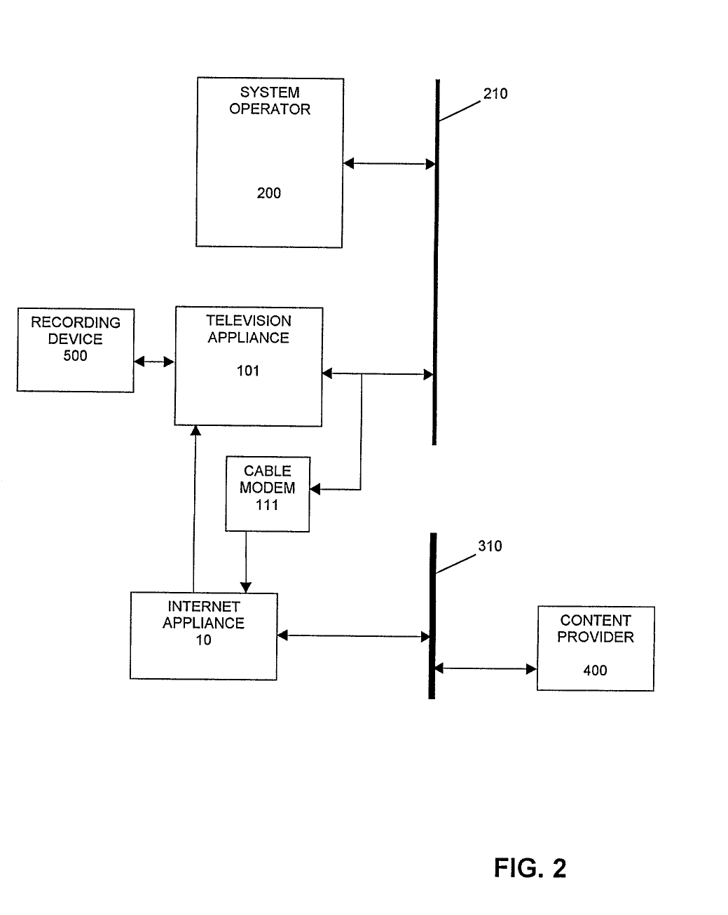

As shown in FIGS. 1 and 2, the present invention provides methods and systems for tuning a television appliance (100, 101) using an internet appliance 10. As shown in FIG. 1, a first network 310 provides a program advertisement to the internet appliance 10. A second network 210 provides channel map information to the internet appliance 10 (e.g., via television appliance 100 and cable modem 110 of FIG. 1 or via television appliance 101 and cable modem 111 of FIG. 2), which channel map information identifies a channel for a program advertised in the program advertisement. The program advertisement is displayed on the internet appliance 10. The advertised program may be selected via interaction with the program advertisement using the internet appliance 10. A tune command is communicated to the television appliance 100 from the internet appliance 10 in response to the interaction with the program advertisement. The television appliance 100 tunes to the channel in response to the tune command.

The tune command for the advertised program is created by the internet appliance 10 based on the channel map information received from a system operator 200 via the network 210 and the cable modem 110.

The television appliance 100 may comprise one of a television, a digital video recorder, a video cassette recorder, a personal versatile recorder, a set-top terminal, or the like. For ease of illustration, only one television appliance 100 and its associated internet appliance 10 is shown in the Figures. Those skilled in the art will appreciate that the television appliance 100 is one of a plurality of television appliances in the television system governed by a particular system operator 200 from a particular headend. The internet appliance may be designed such that it can be used with a variety of television appliances in the same way that a universal remote may be used with a variety of television appliances. In other words, the particular internet appliance 10 need not be associated with a single television appliance 100, and a user may use the same internet appliance 10 with any television appliance coupled to the television network controlled by the system operator 200.

The program advertisement may be provided to the internet appliance 10 by either a content provider 400 or a system operator 200. The content provider 400 may be, for example, a television network such as ABC, CBS, NBC, ESPN, HBO, CNN, or the like. The content provider 400 may also be an internet content provider, a specific content provider for such program advertisements, a pay-per-view content provider, or the like. The system operator 200 may be a local system operator at a local television headend, a national system operator at a national headend, or a system operator at a satellite uplink station. The system operator 200 may also take over the role of content provider 400 for purposes of supplying the program advertisement to the internet appliance 10. Alternatively, the system operator 200 may act as a gateway for the content provider 400.

The channel map information may be provided to the internet appliance 10 by one of a content provider 400 or a system operator 200. In one embodiment of the invention, the channel map information may be provided from the television appliance 100 to the internet appliance 10. In this embodiment, the channel map information is provided from the system operator 200 to the television appliance 100 over the second network 210. The television appliance 100 then provides the channel map information to the internet appliance 10 via cable modem 110.

Although FIGS. 1 and 2 show only a single content provider 400, those skilled in the art will appreciate that multiple content providers may each provide program advertisements or the channel map information to the internet appliance 10.

The first network 310 may comprise an external communication network, such as the internet, the world wide web, a national network, a wide area network, a local area network, or any other network to which computers may be connected on a generally world wide basis. The second network 210 may comprise a system operator network, which may be, for example, a local area network, a large area network, a national network, or other similar network where access is controlled by a system operator 200.

The internet appliance 10 may cause the television appliance 100 to tune to the program advertised in the program advertisement in the same manner as a conventional remote control is used to tune a television appliance 100. For example, the internet appliance may emit an infrared or RF signal that is received by the television appliance and processed to control the television tuner. The television appliance 100 may include a cable modem 110, as shown in FIG. 1. Alternatively, as shown in FIG. 2, the television appliance 101 may be associated with an external cable modem 111. The selected program channel map information may be communicated from the internet appliance 10 to the television appliance 100, 101 via the cable modem 110, 111.

In the embodiment of FIG. 2, the channel map information is provided from the system operator 200 to both the television appliance 101 and the external cable modem 111 via the second network 210. The cable modem 111 then communicates the channel map information to the internet appliance 10.

The advertisement may comprise a hypertext markup language (HTML) link. The HTML link may include a channel identifier from the channel map corresponding to the program identified in the advertisement. The tune command may comprise the channel identifier, which enables the television appliance to tune to the proper channel to receive the advertised program.

The advertisement may be provided to the internet appliance 10 from the content provider 400 via the use of an internet protocol datagram. The datagram may be constructed using hyper text transfer protocol (HTTP), as well known in the art.

The advertisement may appear on the internet appliance 10 as a pop-up advertisement. In one embodiment, the advertisement is targeted for display on a specific location on a display of the internet appliance 10. For example, the advertisement may be displayed on the lower right corner of the display, or at any other predefined location.

The program advertisement may comprise a targeted advertisement directed to a specific viewer or group of viewers based, e.g., on demographic information. The targeted advertisement can also be based on, for example, customer preference, which may be determined through surveys conducted via mail, the internet, telephone, in person, or by any other suitable means. In addition, customer preference may be determined by tracking the programs viewed by a viewer or by tracking the internet content accessed with the internet appliance.

Interactive web pages which relate to the advertised program may be displayed on the internet appliance 10 in response to tuning the television appliance 100 to the channel associated with that program. Such a feature would enable, for example, interactive television capabilities, such as on-line shopping (e.g., including purchasing items displayed in television commercials or during the television program), viewer polls and voting, web pages providing information related to the advertised program, and the like.

A recording device 500 may be provided to record the advertised program in response to the tuning step. The recording device 500 may be one of a digital video recorder associated with the television appliance, a personal versatile recorder system integrated into the television appliance, a video cassette recorder, or the like. The recording device 500 may be integrated into the television appliance 100 or be a separate device associated with the television appliance 100.

The internet appliance 10 may comprise one of a wireless web pad, a personal computer, a web-enabled personal digital assistant, or similar internet enabled device.

The television appliance 100 and the internet appliance 10 may communicate via one of (i) an infrared link, or (ii) an RF link. Alternatively, the internet appliance 10 may communicate with the television appliance 100 via a cable connection, a in-home network, or other similar means of wired or wireless communication.

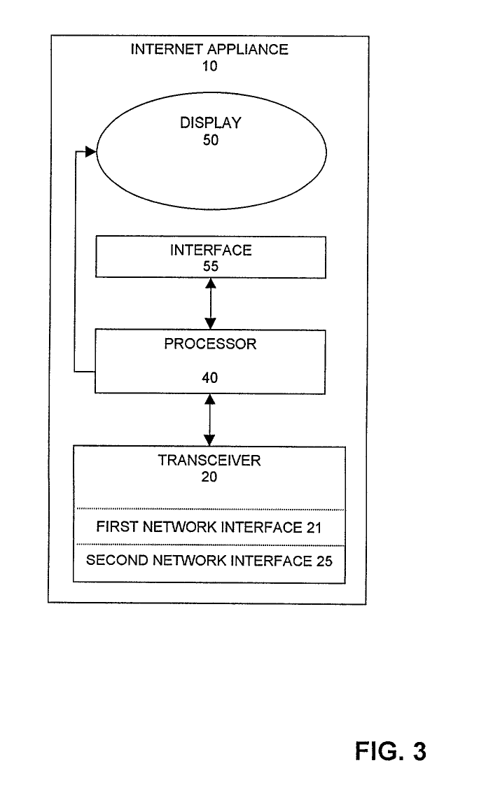

In accordance with the present invention, an internet appliance 10 for tuning a television appliance 100, 101 is also provided as shown in FIG. 3. The internet appliance 10 includes a transceiver 20 which incorporates a first network interface 21 for receiving a program advertisement via a first network (e.g., network 310 of FIG. 1). The transceiver 20 also incorporates a second network interface 25 for receiving channel map information via a second network (e.g., network 210 of FIG. 1), which channel map information identifies a channel for a program advertised in the program advertisement. A display 50 is provided for displaying the program advertisement. A user interface 55, such as a touch screen implemented on display 50, is provided for selecting the advertised program via interaction with the program advertisement. A processor 40 is provided for generating a tune command for the selected advertised program. The tune command is communicated to the television appliance from the internet appliance 10 (e.g., via transceiver 20 or via a separate infrared or RF transmitter) to cause the television appliance to tune to the channel for the program advertised in the advertisement. The processor 40 creates the tune command for the advertised program based on the channel map information received from the second network via interface 25 and transceiver 20.

The first and second network interfaces 21, 25 also enable the transceiver 20, and hence the internet appliance 10, to communicate with the television appliance 100 and the cable modem 110, as well as the first network 310 and the second network 210 as shown in FIGS. 1 and 2.

Those skilled in the art will appreciate that the user interface 55 may take a variety of forms, such as a touch screen, a key pad, a touch pad, a mouse, or the like. The internet appliance 10 may comprise one of a wireless web pad, a personal computer, a web-enabled personal digital assistant, or other similar web enabled device.

Those skilled in the art will also appreciate that the process of selecting or interacting with the program advertisement displayed in the display 50 may include clicking on the advertisement using a mouse, selecting the advertisement with a keystroke, touching the advertisement with a pen or finger, entering a keyboard command, or the like, depending on the type of user interface 55 provided on the internet appliance 10.

It should now be appreciated that the present invention provides advantageous methods and apparatus for tuning a television appliance using an internet appliance in response to a selection of a program advertisement.

Although the invention has been described in connection with various illustrated embodiments, numerous modifications and adaptations may be made thereto without departing from the spirit and scope of the invention as set forth in the claims.

What is claimed is:

1. A method for tuning a television appliance using an internet appliance, comprising the steps of:
providing a program advertisement to said internet appliance;
providing channel map information to said internet appliance which identifies a channel for a program advertised in said program advertisement;
displaying said program advertisement on said internet appliance;
selecting said advertised program via interaction with said program advertisement;
communicating a tune command to said television appliance from said internet appliance; and
tuning said television appliance to said channel in response to said tune command.

2. A method in accordance with claim 1, further comprising:
creating said tune command for said advertised program based on said channel map information.

3. A method in accordance with claim 1, wherein said television appliance comprises one of a television, a digital video recorder, a video cassette recorder, a personal versatile recorder, or a set-top terminal.

4. A method in accordance with claim 1, wherein the program advertisement is provided to the internet appliance by one of a content provider or a system operator.

5. A method in accordance with claim 1, wherein the channel map information is provided to the internet appliance by one of a content provider or a system operator.

6. A method in accordance with claim 1, wherein the channel map information is provided from the television appliance to the internet appliance.

7. A method in accordance with claim 1, wherein:
said program advertisement is provided to the internet appliance via an external communication network; and
said channel map information is provided to the internet appliance by a system operator.

8. A method in accordance with claim 1, wherein said television appliance either (i) includes a cable modem, or (ii) is associated with a cable modem.

9. A method in accordance with claim 8, wherein said selected program channel map information is communicated from the internet appliance to the television appliance via said cable modem.

10. A method in accordance with claim 1, wherein said advertisement comprises a hypertext markup language (HTML) link.

11. A method in accordance with claim 10, wherein said HTML link includes a channel identifier from said channel map corresponding to the program identified in said advertisement.

12. A method in accordance with claim 11, wherein said tune command comprises said channel identifier.

13. A method in accordance with claim 1, wherein said advertisement is provided to said internet appliance via the use of an internet protocol datagram.

14. A method in accordance with claim 1, wherein said datagram is constructed using hyper text transfer protocol (HTTP).

15. A method in accordance with claim 1, wherein said advertisement appears on said internet appliance as a pop-up advertisement.

16. A method in accordance with claim 1, wherein said advertisement is targeted for display on a specific location on the internet appliance.

17. A method in accordance with claim 1, further comprising:
displaying interactive web pages on said internet appliance which relate to said advertised program in response to tuning said television appliance to said channel.

18. A method in accordance with claim 1, further comprising:
setting a recording device to record said advertised program in response to said tuning step.

19. A method in accordance with claim 18, wherein said recording device is one of a digital video recorder associated with said television appliance, a personal versatile recorder system integrated into said television appliance, or a video cassette recorder.

20. A method in accordance with claim 1, where said television appliance and said internet appliance communicate via one of (i) an infrared link, or (ii) an RF link.

21. A method in accordance with claim 1, wherein said internet appliance comprises one of a wireless web pad, a personal computer, or a web-enabled personal digital assistant.

22. A method in accordance with claim 1, wherein the program advertisement comprises a targeted advertisement directed to one of a specific viewer or group of viewers.

23. A system for enabling a television appliance to be tuned using an internet appliance, comprising:
a first network for providing a program advertisement to said internet appliance; and
a second network for providing channel map information to said internet appliance which identifies a channel for a program advertised in said program advertisement;
wherein:
said program advertisement is displayed on said internet appliance;
said advertised program is selected via interaction with said program advertisement;
a tune command is communicated to said television appliance from said internet appliance in response to said interaction; and
said television appliance tunes to said channel in response to said tune command.

24. A system in accordance with claim 23, wherein:
said internet appliance creates said tune command for said advertised program based on said channel map information.

25. A system in accordance with claim 23, wherein said television appliance comprises one of a television, a digital video recorder, a video cassette recorder, a personal versatile recorder, or a set-top terminal.

26. A system in accordance with claim 23, wherein the program advertisement is provided to the internet appliance by one of a content provider or a system operator.

27. A system in accordance with claim 23, wherein the channel map information is provided to the internet appliance by one of a content provider or a system operator.

28. A system in accordance with claim 23, wherein the channel map information is provided from the television appliance to the internet appliance.

29. A system in accordance with claim 23, wherein:
said first network comprises an external communication network; and
said second network comprises a system operator network.

30. A system in accordance with claim 23, wherein said television appliance either (i) includes a cable modem, or (ii) is associated with a cable modem.

31. A system in accordance with claim 30, wherein said selected program channel map information is communicated from the internet appliance to the television appliance via said cable modem.

32. A system in accordance with claim 23, wherein said advertisement comprises a hypertext markup language (HTML) link.

33. A system in accordance with claim 32, wherein said HTML link includes a channel identifier from said channel map corresponding to the program identified in said advertisement.

34. A system in accordance with claim 33, wherein said tune command comprises said channel identifier.

35. A system in accordance with claim 23, wherein said advertisement is provided to said internet appliance via the use of an internet protocol datagram.

36. A system in accordance with claim 23, wherein said datagram is constructed using hyper text transfer protocol (HTTP).

37. A system in accordance with claim 23, wherein said advertisement appears on said internet appliance as a pop-up advertisement.

38. A system in accordance with claim 23, wherein said advertisement is targeted for display on a specific location on the internet appliance.

39. A system in accordance with claim 23, wherein:
interactive web pages are displayed on said internet appliance which relate to said advertised program in response to tuning said television appliance to said channel.

40. A system in accordance with claim 23, wherein:
a recording device is set to record said advertised program in response to said tuning step.

41. A system in accordance with claim 40, wherein said recording device is one of a digital video recorder associated with said television appliance, a personal versatile recorder system integrated into said television appliance, or a video cassette recorder.

42. A system in accordance with claim 23, where said television appliance and said internet appliance communicate via one of (i) an infrared link, or (ii) an RF link.

43. A system in accordance with claim 23, wherein said internet appliance comprises one of a wireless web pad, a personal computer, or a web-enabled personal digital assistant.

44. A system in accordance with claim 23, wherein the program advertisement comprises a targeted advertisement directed to one of a specific viewer or group of viewers.

45. An internet appliance for tuning a television appliance, comprising:
a first network interface for receiving a program advertisement via a first network;
a second network interface for receiving channel map information via a second network, which channel map information identifies a channel for a program advertised in said program advertisement;
a display for displaying said program advertisement;
a user interface for selecting said advertised program via interaction with said program advertisement; and
a processor for generating a tune command for said selected advertised program;
wherein said tune command is communicated to said television appliance from said internet appliance to cause said television appliance to tune to said channel.

46. An internet appliance in accordance with claim 45, wherein:
said processor creates said tune command for said advertised program based on said channel map information.

47. An internet appliance in accordance with claim 45, wherein said television appliance comprises one of a television, a digital video recorder, a video cassette recorder, a personal versatile recorder, or a set-top terminal.

48. An internet appliance in accordance with claim 45, wherein the program advertisement is provided to the internet appliance by one of a content provider or a system operator.

49. An internet appliance in accordance with claim 45, wherein the channel map information is provided to the internet appliance by one of a content provider or a system operator.

50. An internet appliance in accordance with claim 45, wherein the channel map information is provided from the television appliance to the internet appliance.

51. An internet appliance in accordance with claim 45, wherein:
said first network comprises an external communication network; and
said second network comprises a system operator network.

52. An internet appliance in accordance with claim 45, wherein said television appliance either (i) includes a cable modem, or (ii) is associated with a cable modem.

53. An internet appliance in accordance with claim 52, wherein said selected program channel map information is communicated from the internet appliance to the television appliance via said cable modem.

54. An internet appliance in accordance with claim 45, wherein said advertisement comprises a hypertext markup language (HTML) link.

55. An internet appliance in accordance with claim 54, wherein said HTML link includes a channel identifier from said channel map corresponding to the program identified in said advertisement.

56. An internet appliance in accordance with claim 55, wherein said tune command comprises said channel identifier.

57. An internet appliance in accordance with claim 45, wherein said advertisement is provided to said internet appliance via the use of an internet protocol datagram.

58. An internet appliance in accordance with claim 45, wherein said datagram is constructed using hyper text transfer protocol (HTTP).

59. An internet appliance in accordance with claim 45, wherein said advertisement appears on said internet appliance display as a pop-up advertisement.

60. An internet appliance in accordance with claim 45, wherein said advertisement is targeted for display on a specific location on the internet appliance display.

61. An internet appliance in accordance with claim 45, wherein:
interactive web pages which relate to said advertised program are displayed on said display in response to tuning said television appliance to said channel.

62. An internet appliance in accordance with claim 45, wherein:
a recording device is set to record said advertised program in response to said tuning step.

63. An internet appliance in accordance with claim 62, wherein said recording device is one of a digital video recorder associated with said television appliance, a personal versatile recorder system integrated into said television appliance, or a video cassette recorder.

64. An internet appliance in accordance with claim 45, where said television appliance and said internet appliance communicate via one of (i) an infrared link, or (ii) an RF link.

65. An internet appliance in accordance with claim 45, wherein said internet appliance comprises one of a wireless web pad, a personal computer, or a web-enabled personal digital assistant.

66. An internet appliance in accordance with claim 45, wherein the program advertisement comprises a targeted advertisement directed to one of a specific viewer or group of viewers.
